(19) United States
(12) Patent Application Publication
(10) Pub. No.: US 2006/0006688 A1
(43) Pub. Date: Jan. 12, 2006

(54) Mechanism for controlling a member to be controlled, such as a selective air distribution member for a heating, ventilating and/or air conditioning system of a vehicle passenger compartment

(75) Inventors: Eric Droulez, Suresnes (FR); Serge Pouysegur, Le Perray en Yvelines (FR); Franck Truillet, Rueil Malmaison (FR)

Correspondence Address: Valeo Climate Control Corp.;Intellectual Property Dept., 4100 North Atlantic Boulevard, Auburn Hills, MI, 48326, US

(73) Assignee: Valeo Climatisation S.A., La Verriere (FR)

(21) Appl. No.: 11/175,495

(22) Filed: Jul. 6, 2005

(30) Foreign Application Priority Data
Jul. 7, 2004 (FR) 04 07558

(51) Int. Cl. B62D 25/14

(52) U.S. Cl. 296/72

(57) ABSTRACT

The invention is related to a mechanism for controlling at least one member to be controlled (8, 9, 10, 11), which is housed inside a structural element (1) of a vehicle, for example. This mechanism comprises means for controlling the member (8, 9, 10, 11), which are borne by a support (12, 13) and which are connected to a control member (17). The element (12, 13) is attached to the structural element (1) and consists of at least one plate (14, 15, 16) equipped with centering means (24) and attachment means (25) on the structural element (1), to control the member (8, 9, 10, 11) housed inside the structural element from outside the latter.

### TECHNICAL FIELD OF THE INVENTION

The invention relates to the field of mechanisms for controlling a member to be controlled, for heating, ventilation and/or air-conditioning systems, in particular for a vehicle passenger compartment. The object is such a control mechanism specifically applied to a selective air distribution mechanism provided in such a system.

### PRIOR ART

It is common practice to control a member using a control mechanism. More specifically, in the automobile industry, such a member can be a selective air distribution mechanism, or even a solenoid or a steering and/or control member of a functional element of the vehicle. Such control mechanisms are commonly supported by a structural element of the vehicle, such as a casing of a heating, ventilation and/or air-conditioning system, or an instrument panel.

In heating, ventilation and/or air-conditioning installations for vehicle passenger compartments, these commonly comprise a casing for housing a heat exchanger. This casing usually also houses a mechanism for the selective distribution of air evacuated from the casing to different air routing conduits in specific zones of the vehicle passenger compartment. Such distribution mechanisms consist primarily of valves movably mounted on the casing, which cooperate with control members that can be actuated from the interior of the passenger compartment by an occupant of the vehicle, especially from a control panel. These valves are, for example, drum valves, butterfly valves, film valves, flag valves, extensible valves and/or other similar mobile distribution members. The cooperation between the valves and the control members is commonly achieved by way of control means of the cable or rod type, by micromotors or the like, which optionally implement cam, rack and/or lever means. Reference could be made, for example, to document FR2757596 (VALEO CLIMATISATION) which describes such arrangements.

The general problem to be resolved is the arrangement of such selective air distribution mechanisms, which must have the minimum possible bulk, especially so as not to take up too much space in the casing of the installation. In addition, the control means of the valves must have limited surfaces creating an obstacle to the circulation of air, especially to avoid pressure losses, while providing satisfactory and lasting reliability. It is clear that these control means must be sturdy, yet consist of a minimum number and mass of mechanical pieces. In addition, the valves must be positioned precisely on the air trajectory so as to reinforce their efficacy. Also, such selective air distribution mechanisms are suitable for comprising several valves, whereof the different relative positions from one valve to the other must be in correspondence, and even in alignment for a common trajectory zone, so as not to create an obstacle to their respective mobility. The risk of increasing the space requirement and the complexity of the mechanism for enabling such a correspondence between the different respective trajectories described by the valves is evident here.

The use of a structural element of the vehicle passenger compartment, such as a reinforcing beam, an instrument panel or the like, to house said air routing conduits originating from the casing, and more specifically exiting from the selective air distribution mechanisms which it houses has also been proposed. Reference could be made, for example, to the documents FR2789043 (VALEO CLIMATISATION SA) and WO0154964 (BEHR GmbH) which describe such arrangements.

A general difficulty to be overcome is the organization of a control mechanism borne by a structural element, which allows a member, such as a selective air distribution mechanism, a motor or a solenoid in general, to be controlled from the outside of this structural element, whereof the space requirement remains limited for satisfactory, reliable and durable efficacy and precision of control.

### OBJECT OF THE INVENTION

The general aim of the present invention is to reduce the abovementioned consequences associated with space requirement of the control mechanisms, at the same time offering the precision; efficacy, reliability and shelf life appropriate for such a mechanism.

A particular aim of the present invention is to propose such a control mechanism applied to a selective air distribution mechanism of heating, ventilation and/or air-conditioning systems for vehicle passenger compartments. The present invention in particular aims to propose such a mechanism whereof the bulk and the structure help to limit losses in pressure of the air passing through them, while remaining reliable, precise and sturdy.

The mechanism of the present invention is a control mechanism of at least one member to be controlled. This member to be controlled can be a solenoid, such as a manual or motorized solenoid, or even a steering member of a functional element of the vehicle, monitor or the like, for example. As will be specified below, and according to a preferred use of the present invention, this member to be controlled consists in particular of at least one mobile valve for selective air distribution. This valve is, for example, a drum valve, a butterfly valve, a film valve, a flag valve, an extensible valve and/or another similar member for distribution of air between at least two air distribution ducts arranged inside an air circulation chamber.

The member to be controlled is more specifically positioned inside a structural element, especially of a vehicle. According to an aspect of the present invention, this structural element is, for example, an instrument panel or a transverse reinforcing beam of the vehicle, which optionally houses a selective air distribution module if the member to be controlled is at least one valve.

The mechanism of the invention generally comprises means for controlling the member to be controlled, which are borne by a support and which cooperate with a control member. More precisely, the support is attached to the structural element, and consists of at least one plate. This plate is equipped with centering and attachment means on the structural element, for controlling the member housed inside the structural element from outside the latter.

As mentioned above, the control member controls, for example, a selective air distribution mechanism of a heating, ventilation and/or air-conditioning system for a vehicle passenger compartment. The means for controlling the member to be controlled, in particular a valve, are advantageously arranged in the general plane of the plate, so that the bulk of the mechanism is entirely contained in this general plane. It is clear that such an advantageous organization of the control mechanism, in a plate supporting control means in its general plane, enables the valves to be controlled reliably and precisely, by limiting the bulk of the mechanism attached to the structural element in an adjacent plane of one of its walls.

According to a first alternative, the means for controlling the member to be controlled, in particular a valve, are placed between the support and an external wall of the structural element, inside a space arranged between the external wall of the structural element and the plate.

According to another alternative, the means for controlling the member to be controlled, especially a valve, are placed inside the structural element, and are attached in particular to a complementary member which it houses, such as a module for selective air distribution.

It appears that the means for controlling the valves of the selective air distribution mechanism do not constitute an obstacle to the circulation of air, due to their arrangement outside the space reserved for this circulation. Such arrangements are advantageously made possible with reliable operation and suitable sturdiness for the minimum possible bulk, by the organization of the plate support attached to a wall of the structural element, and especially the external surface of the latter and/or a wall of a selective air distribution module which it houses.

According to various alternative embodiments, the means for controlling the valve are, for example, of the connecting rod and crank type, or the cam type. If the plate supports at least several members to be controlled, in particular valves, the control means respectively assigned to them can be different types.

By way of example, and according to a first alternative embodiment of the means for controlling the member to be controlled, especially a valve, these are of the connecting rod and crank type, and comprise a set of articulated rods, preferably coplanar so as to avoid an increase in the bulk of the mechanism, on pivoting members forming a crank. These pivoting members are especially movably mounted on the plate, and cooperate with at least one member to be controlled.

By way of example, and according to a second alternative embodiment of the means for controlling the member to be controlled, especially a valve, said means are of the cam type, and comprise at least one arm for controlling at least the member to be controlled. This control arm is in particular movably guided along at least one cam race arranged on the plate.

The centering and attachment preferably include cooperating interlocking reliefs arranged respectively on the plate and on the structural element, and means for mounting the plate onto the latter, such as by interlocking, screwing or similar means.

The centering and attachment means are capable of consisting of separate centering members on the one hand and attachment members on the other hand, such as centering pins and means for attachment by screwing, in particular, or they may consist of a variety of members, such as of the elastic interlocking type between cooperating reliefs determining the relative position of the support with respect to the structural element. Wherever necessary, the support of the valve by the structural element at its respective ends, and its relation to the support, makes use of said centering and attachment means, by advantageously allowing the number of elements composing the mechanism to be reduced so as to reduce the mass and bulk without affecting its precision or sturdiness.

If the member to be controlled is at least one valve pivotably connected, for its control, to the structural element, the latter is in particular arranged inside an air circulation chamber positioned inside the structural element.

The structural element preferably houses a selective air distribution module, consisting in particular of a partitioned caisson for air distribution. In this case, the valve at least is capable of being pivotably connected by its ends to the caisson, by being connected at one of its ends to the control means supported by the plate.

The control means are also capable of being advantageously placed between an internal wall of the structural element and an external wall of the module. In this case, the centering and attachment means preferably include cooperating interlocking reliefs arranged on the plate and the module, respectively, and means for mounting the plate onto the latter.

According to various alternative embodiments, and if the mechanism comprises at least two pivotably connected valves, the latter are indifferently oriented according to parallel axes on the same plate of the support, or according to intersecting, and orthogonal axes in particular on respective plates of the support, which plates are in particular oriented in a V-shape in relation to one another.

More specifically, and according to a possible embodiment, the control mechanism comprises at least two valves controlled according to parallel axes supported by the same plate. More specifically still, and according to another possible embodiment, the control mechanism comprises at least two valves controlled according to axes, in particular intersecting, which are comprised in different planes and supported by respective plates.

According to the various alternative embodiments of the structural element, the transverse reinforcing beam of the vehicle or the instrument panel advantageously are provided in the air circulation chamber and, by partitioning, define respective air circulation ducts, if necessary by means of the selective air distribution module. It is specifically preferable for the structural element to define the air circulation ducts by means of at least one module formed by at least one partitioned caisson which it houses, with the valve being attached at least by its ends inside and to said module.

### DESCRIPTION OF FIGURES

The present invention can be better understood from the following description of possible embodiments, with reference to the attached figures, in which:

FIG. 1 and FIG. 2 are perspective illustrations, viewed respectively from the rear and from the front, partially in cut-away view, of a structural beam of a vehicle passenger compartment equipped with a pair of selective distribution mechanisms of the present invention.

FIG. 3 is a perspective illustration of a first alternative embodiment of a selective air distribution mechanism of the present invention.

FIG. 4 and FIG. 5 are perspective and plan view illustrations, respectively, of the mechanism illustrated in FIG. 3, whereof the valves are removed.

FIG. 6 and FIG. 7 are perspective and plan view illustrations, respectively, of a second alternative embodiment of a selective air distribution mechanism of the present invention.

FIG. 8 is a perspective illustration of the mechanism shown in FIG. 6 and FIG. 7, whereof the valves are removed.

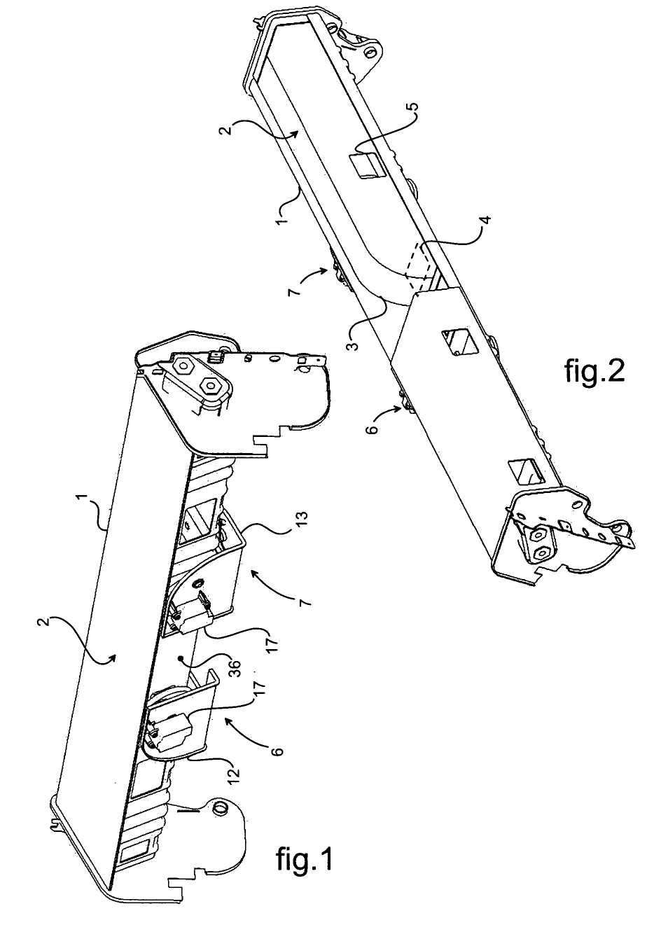

In FIG. 1 and FIG. 2 a structural beam (1) of a vehicle passenger compartment is used to provide, in its internal volume, a chamber (2) for the circulation of air originating from a heating, ventilation and/or air-conditioning installation, not shown. In FIG. 2, this chamber (2) is specifically formed by at least one partitioned caisson (3) which is housed inside the beam (1). The latter (1) comprises openings to allow air (4) to enter the chamber (2), and openings (5) for selectively evacuating air to respective conduits, aeration apertures or similar members not shown here.

Also in reference to the other figures, the distribution of the circulation of air inside the chamber (2) is effected by means of selective air distribution mechanisms (6, 7) using valves (8, 9; 10, 11). These valves are movably mounted on a support (12, 13), which is attached to the outer surface of the beam (1). According to another alternative embodiment, not shown, the support (12, 13) is capable of being attached to the partitioned caisson (3).

More specifically, according to alternative embodiments not shown, at least the control means (18, 19, 20, 21), and even the supports (12, 13) are attached inside the structural element (1), but nevertheless outside the air circulation chamber (2). In this case, it is conceivable to provide, in the external wall (36) of the structural element (1), a window for inserting the control means (18, 19, 20, 21) as well as the supports (12, 13) so that they can be attached to the caisson (3).

The support (12, 13) consists of at least one plate (14, 15, 16), which supports, on its outer surface, control members (17) for controlling valves (8, 9, 10, 11), such as solenoids, which are known in this field. The latter (17) cooperate with the valve (8, 9, 10, 11) to which they are assigned by means of control means (18, 19, 20, 21) which are positioned between the support (12, 13) and the external surface of beam 1, and as necessary positioned between the caisson (3) and the beam (1), and are entirely arranged in the general plane of the corresponding plate (14, 15, 16). Such an organization of these selective air distribution mechanisms makes it unnecessary to provide the control means (18, 19, 20, 21) for controlling the valves (8, 9, 10, 11) inside the chamber (2), so that they do not constitute an obstacle to the free circulation of air, while limiting the bulk contained entirely in an plane adjacent to the general plane of extension of the wall (36) of the structural element (1), or the wall of the caisson which it houses, to which the supports (12, 13) are attached.

In the alternative embodiments shown, there are two valves (8, 9, 10, 11) for each of the supports (12, 13). These valves are supported at their ends (22, 23) by the beam (1), in particular if required by means of the caisson (3) housed and attached inside the beam (1). The support of the valves (8, 9, 10, 11) by the beam (1) is achieved especially by utilizing a wall or an internal partition of the chamber (2), for example constituted by a wall (36) of the beam (1) or if necessary a wall of the caisson (3).

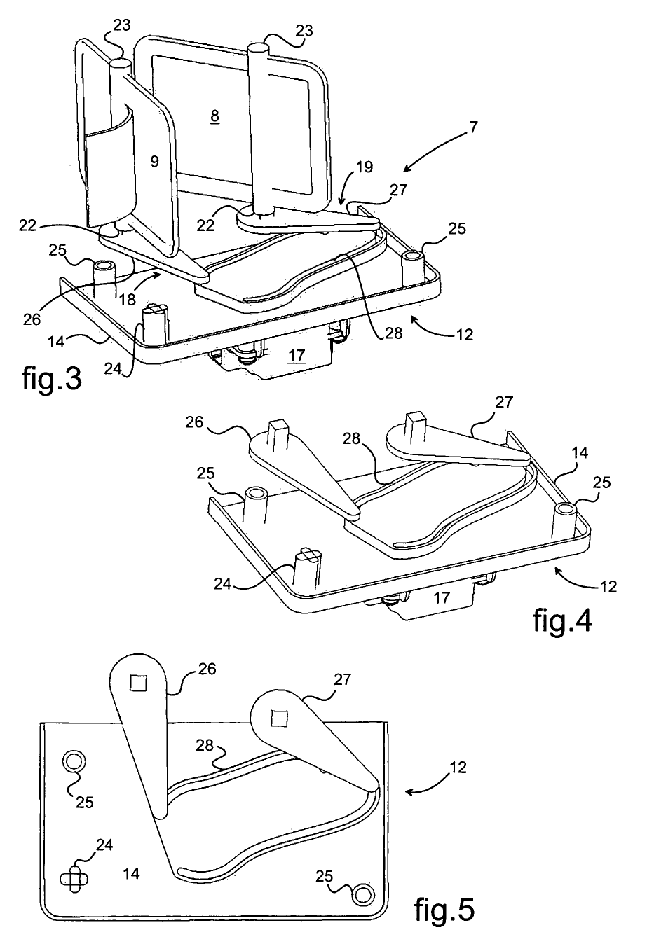

In FIGS. 3 to 5, the valves (8, 9) are parallel and connected at one (22) of their ends with the control means (18, 19) supported by the same plate (14), which essentially constitutes the support (12). This plate (14) comprises at least one centering finger (24) intended to be received by interlocking inside a shaft of the beam (1) and/or on the caisson (3), and cylinders (25) for receiving screws for attaching the plate (14) to the beam (1) and/or the caisson (3).

According to similar variant embodiments not illustrated, the finger (24) is capable of being arranged on the beam (1) and/or on the caisson (3), whereas the shaft is arranged on, the plate (14), or the centering and the attachment of the plate (14) on the beam (1) and/or the caisson (3) are jointly carried out by the tight interlocking of cooperating members respectively arranged on the support (12, 13) and the beam (1) and/or the caisson (3).

The control means (18, 19) for controlling the valves (8, 9) are of the cam type, and comprise arms (26, 27), which are respectively assigned to each of the valves (8, 9) which they control by one of their ends, and a guide path (28) of the other end of the arms (26, 27), which guide path (28) is provided in the cam race.

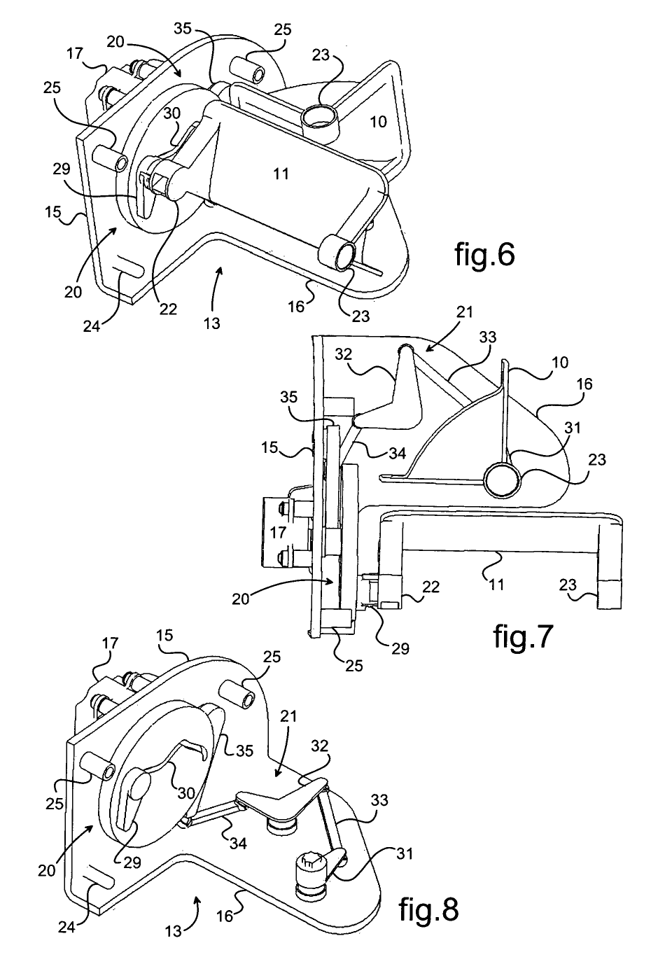

In FIGS. 6 to 8, the valves (10, 11) are oriented orthogonally relative to one another, and are supported by the beam (1) and/or on the caisson (3). The methods for attaching the support (13) to the beam (1) are similar to those described previously, with at least one of the plates (15, 16), and especially the plate (15) in the embodiment shown, comprising a centering finger (24) and cylinders (25) for receiving attachment screws.

The control means (20) for controlling one (11) of the valves are of the cam type, including, as previously described, an arm (29) and a guide path (30) forming a cam race. The control means (21) for the other valve (10) are of the connecting rod and crank type. More specifically, the valve (10) cooperates with a first crank (31), which itself cooperates with a second crank (32) by means of a first rod (33). This second crank (32) itself cooperates with the corresponding solenoid (17) by means of a second rod (34) and a control arm (35), and the latter extends in the general plane of a first (15) of the plates supporting the control means (20) for controlling the other valve (11).

1. Mechanism for controlling at least one member to be controlled (8, 9, 10, 11) housed inside a structural element (1), especially a vehicle, which mechanism comprises means for controlling the member (8, 9, 10, 11) which are borne by a support (12, 13) and which cooperate with a control member (17), characterized in that the support (12, 13) is attached to the structural element (1) and consists of at least one plate (14, 15, 16) equipped with centering (24) and attachment (25) means on the structural element (1) for controlling the member (8, 9, 10, 11) housed inside the structural element from outside the latter.

2. Control mechanism as claimed in claim 1, characterized in that the control member is a solenoid.

3. Control mechanism as claimed in claim 1, characterized in that the control member controls a selective air distribution mechanism of a heating, ventilation and/or air-conditioning system for a vehicle passenger compartment.

4. Control mechanism as claimed in any one of the preceding claims, characterized in that the structural element is an instrument panel.

5. Control mechanism as claimed in any one of the preceding claims, characterized in that the structural element is a transverse reinforcing beam (1) of the vehicle.

6. Control mechanism as claimed in any one of the preceding claims, characterized in that the control means (18, 19, 20, 21) for the member to be controlled (8, 9, 10, 11) are arranged in the general plane of the plate (14, 15, 16), so that the bulk of the mechanism is contained entirely in this general plane.

7. Control mechanism as claimed in any one of the preceding claims, characterized in that the control means (18, 19, 20, 21) for the member to be controlled (8, 9, 10, 11), are placed between the support (12, 13) and an external wall (36) of the structural element (1).

8. Control mechanism as claimed in any one of claims 1 to 6, characterized in that the control means (18, 19, 20, 21) for the member to be controlled (8, 9, 10, 11) are placed inside the structural element.

9. Control mechanism as claimed in any one of the preceding claims, characterized in that the control means (21) for the member to be controlled (10) are of the connecting rod and crank type, comprising a set of rods (33, 34) pivotably connected to pivoting members forming a crank (31, 32) movably mounted on the plate (16), and cooperating with at least one member to be controlled (8, 9, 10, 11).

10. Control mechanism as claimed in any one of claims 1 to 8, characterized in that the control means (18, 19, 20) for the member to be controlled (8, 9, 11) are of the cam type, comprising at least one arm (26, 27, 29) for controlling at least the member (8, 9, 11) to be controlled, which is movably guided along at least one cam race (28, 30) arranged on the plate (14, 15).

11. Control mechanism as claimed in any one of the preceding claims, characterized in that the centering (24) and attachment (25) means include cooperating interlocking reliefs arranged respectively on the plate (14, 15) and the structural element (1), and means for mounting the plate (14, 15) onto the latter (1).

12. Control mechanism as claimed in any one of the preceding claims, characterized in that the member to be controlled is at least one pivotably connected valve (8, 9, 10, 11) to be controlled on the structural element (1, 3) and provided inside an air circulation chamber (2) arranged inside the structural element.

13. Control mechanism as claimed in claim 12, characterized in that the structural element jointly houses a selective air distribution module to which at least the valve is pivotably connected at its ends, which valve is connected at one of its ends (23) to the control means (18, 19, 20, 21) supported by the plate (14, 15, 16).

14. Control mechanism as claimed in claim 13, characterized in that the selective air distribution module consists of a partitioned caisson for air distribution.

15. Control mechanism as claimed in any one of claims 13 and 14, characterized in that the control means are placed between an internal wall of the structural element and an external wall of the module.

16. Control mechanism as claimed in any one of claims 13 and 14, characterized in that the centering (24) and attachment (25) means include cooperating interlocking reliefs arranged respectively on the plate (14, 15) and on the module (3), and means for mounting the plate (14, 15) onto the latter (3).

17. Control mechanism as claimed in claim 12, characterized in that it comprises at least two valves (8, 9) controlled according to parallel axes, supported by the same plate (14).

18. Control mechanism as claimed in claim 12, characterized in that it comprises at least two valves (10, 11) controlled according to axes in different planes and supported by respective plates (15, 16).

19. Control mechanism as claimed in claims 5 and 12, characterized in that the transverse reinforcing beam (1) of the vehicle is provided in the air circulation chamber (2) and defines respective air circulation ducts by partition.

20. Control mechanism as claimed in claims 4 and 12, characterized in that the instrument panel is provided in the air circulation chamber (2) and defines respective air circulation ducts by partition.

21. Control mechanism as claimed in claim 13 and either one of claims 19 and 20, characterized in that the structural element (1) defines the air circulation ducts by means of at least one module which it houses.
